(19) United States
(12) Patent Application Publication
(10) Pub. No.: US 2012/0203713 A1
(43) Pub. Date: Aug. 9, 2012

(54) SYSTEM AND METHOD OF MANAGING AN INVESTMENT ON BEHALF OF AN INVESTOR

(75) Inventors: Herschel Phillip MAYERS, Johannesburg (ZA); Adrian Gore, Sandton (ZA); Kenneth Steven Rabson, Johannesburg (ZA)

(73) Assignee: DISCOVERY HOLDINGS LIMITED, Sandton (ZA)

(21) Appl. No.: 13/365,566

(22) Filed: Feb. 3, 2012

(30) Foreign Application Priority Data
Feb. 4, 2011 (ZA) 2011/00938

(51) Int. Cl. G06Q 40/06; G06Q 40/04

(52) U.S. Cl. 705/36 T

(57) ABSTRACT

A system for managing an investment on behalf of an investor includes a monitoring module to monitor the performance of an investment over a predetermined period of time. A calculation module calculates an amount of tax owing based on the performance of the investment for the period of time. A payments module effects a payment to the investor wherein the payment is the amount of tax owing or a percentage of the amount of tax owing and wherein the payment is only effected if the investor does not withdraw the investment before the predetermined period of time.

### BACKGROUND OF THE INVENTION

The present invention relates to a system and method of managing an investment on behalf of an investor.

An investor that has funds invested in an investment unfortunately too often chooses to withdraw their investment before the end of an investment cycle causing a loss to the investor.

The present invention seeks to address this by rewarding the investor for remaining invested in the investment for a predefined period of time and assisting the investor to fund their tax liability.

### SUMMARY OF THE INVENTION

According to one example embodiment there is provided a system for managing an investment on behalf of an investor, the system including:
a monitoring module to monitor the performance of an investment over a predetermined period of time;
a calculation module to calculate an amount of tax owing based on the performance of the investment for the period of time; and
a payments module to effect a payment to the investor wherein the payment is the amount of tax owing or a percentage of the amount of tax owing and wherein the payment is only effected if the investor does not withdraw the investment before the predetermined period of time.

According to another example embodiment there is provided a method for managing an investment on behalf of an investor, the method including:
monitoring the performance of an investment over a predetermined period of time;
calculating an amount of tax owing based on the performance of the investment for the period of time; and
effecting a payment to the investor wherein the payment is the amount of tax owing or a percentage of the amount of tax owing and wherein the payment is only effected if the investor does not withdraw the investment before the predetermined period of time.

### BRIEF DESCRIPTION OF THE DRAWINGS

FIG. 1 is a block diagram illustrating an example system to implement the methodologies described herein; and

FIG. 2 is a block diagram illustrating an example embodiment method.

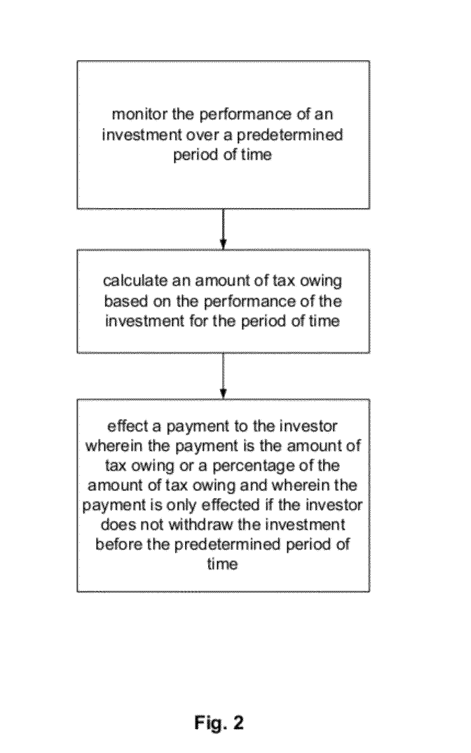

### DESCRIPTION OF EMBODIMENTS

The present invention relates to a system and method of managing an investment on behalf of an investor.

An investor that has funds invested in an investment unfortunately too often chooses to withdraw their investment before the end of an investment cycle causing a loss to the investor.

A system and method for addressing this is described below.

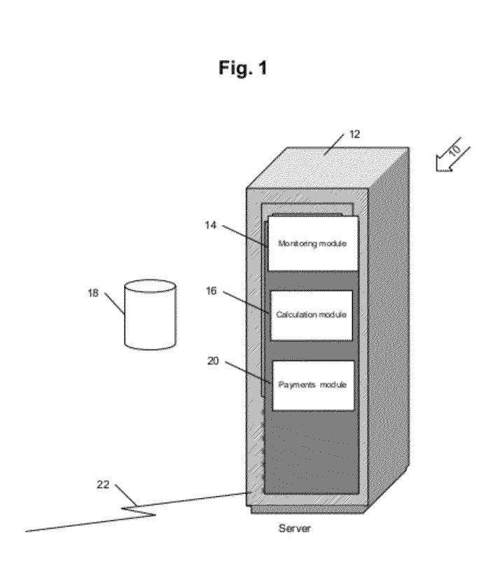

Referring to FIG. 1, an information processing system 10 may include a server 12 that includes a number of modules to implement the present invention.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

In the illustrated example embodiment, the server 12 includes a monitoring module 14 to monitor the performance of an investment over a predetermined period of time.

For purposes of illustration, the period of time will be defined as 5 years as this is often described as an investment cycle.

It will be appreciated that the investment could be any type of investment such as cash, bonds, stocks, property or an investment fund to name but a few examples.

In any event, the monitoring module 14 typically receives investment data via communications network 22 typically from a third party data provider. The network, in one embodiment, is a wide area network, local area network, wireless network, or the like. The investment data may include such information as unit prices, fees paid and income generated by the investment.

The investment data is stored in the memory 18 for use by a calculation module 16.

The calculation module 16 calculates an amount of tax owing based on the performance of the investment for the period of time.

The amount of tax owing will obviously differ from country to country and from time to time and so the calculation module 16 typically accesses rules stored in memory 18 which rules can be applied to the investment data to calculate the amount of tax owing. Information processing system 10 can also be configured so that communication network 22 can be utilized to insure the rules for tax calculation are up-to-date or to update the rules.

In addition, the tax may be capital gains tax and/or income tax depending on the relevant tax laws in the specific country.

A payments module 20 effects the extra payment to the investor. This payment is the amount of tax owing or a percentage of the amount of tax owing and wherein the payment is only effected if the investor does not withdraw the investment before the predetermined period of time.

An example method that will be implemented by the system is described as follows.

In one example, the value of the extra payment at the end of every five years is calculated as 10% of the accumulated realised and unrealised capital gains in the prior five year period. The 10% represents the maximum tax liability as it was derived from a marginal tax rate of 40% multiplied by the inclusion rate for capital gains of 25% which is the current tax law in South Africa at the time of filing this application. This amount is capped to the value of the maximum tax payable by the individual.

In one embodiment, the value of the extra payment is further capped and will only include capital gains to the maximum of 100% of the investment value at the start of every five year period.

The value of the extra payment will proportionally reduce on partial withdrawals before the end of each five year period. No extra payment is payable on full surrender or death before the end of a five year cycle.

An ad hoc contribution to the investment by the investor will be treated as separate policy with its own 5 year term starting at the date of making the contribution.

The funds for the payments to the investors are obtained from a pool of funds funded by a percentage of the fees earned from the investor's portfolio.

It will be appreciated that this benefit aims to reduce full surrender and partial withdrawals from the investment plan by boosting the underlying investment values of policyholders every 5 years with a value equal to the maximum tax liability on any realised or unrealised capital gains over the same period.

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

Although the various embodiments of the present invention are described in the context of a fully functional computer system, those skilled in the art will appreciate that embodiments are capable of being distributed as a program product via CD or DVD, e.g. CD, CD ROM, or other form of recordable media.

What is claimed is:

1. A computer system for managing an investment on behalf of an investor, the system including:
a monitoring module to monitor the performance of an investment over a predetermined period of time;
a calculation module to calculate an amount of tax owing based on the performance of the investment for the period of time; and
a payments module to effect a payment to the investor wherein the payment is the amount of tax owing or a percentage of the amount of tax owing and wherein the payment is only effected if the investor does not withdraw the investment before the predetermined period of time.

2. A computer system according to claim 1 wherein the period of time is 5 years.

3. A computer system according to claim 1 wherein the investment is cash, bonds, stocks, property or an investment fund.

4. A computer system according to claim 1 wherein the monitoring module receives investment data via a communications network.

5. A computer system according to claim 4 wherein the monitoring module receives the investment data from a third party data provider.

6. A computer system according to claim 1 wherein the investment data includes at least some of information as unit prices, fees paid and income generated by the investment.

7. A computer system according to claim 1 wherein the calculation module calculates an amount of tax owing based on the performance of the investment for the period of time.

8. A computer system according to claim 7 wherein the calculation module accesses rules stored in a memory which rules are applied to the investment data to calculate the amount of tax owing.

9. A method for managing an investment on behalf of an investor, the method including:
Monitoring, by a computer, the performance of an investment over a predetermined period of time;
Calculating, by a computer, an amount of tax owing based on the performance of the investment for the period of time; and
Effecting, by a computer, a payment to the investor wherein the payment is the amount of tax owing or a percentage of the amount of tax owing and wherein the payment is only effected if the investor does not withdraw the investment before the predetermined period of time.

10. A method according to claim 9 wherein the period of time is 5 years.

11. A method according to claim 9 wherein the investment is cash, bonds, stocks, property or an investment fund.

12. A method according to claim 9 wherein the monitoring module receives investment data via a communications network.

13. A method according to claim 12 wherein the monitoring module receives the investment data from a third party data provider.

14. A method according to claim 9 wherein the investment data includes at least some of information as unit prices, fees paid and income generated by the investment.

15. A method according to claim 9 wherein the calculation module calculates an amount of tax owing based on the performance of the investment for the period of time.

16. A method according to claim 15 wherein the calculation module accesses rules stored in a memory which rules are applied to the investment data to calculate the amount of tax owing.
